(19) United States
(12) Patent Application Publication
(10) Pub. No.: US 2025/0208071 A1
(43) Pub. Date: Jun. 26, 2025

(54) RECORDING APPARATUS, SYSTEM, METHOD, AND PROGRAM

(71) Applicant: Rigaku Corporation, Tokyo (JP)

(72) Inventors: Yuji HATAYAMA, Tokyo (JP); Masashi KAGEYAMA, Tokyo (JP); Yuji FUKUTA, Tokyo (JP)

(73) Assignee: Rigaku Corporation, Tokyo (JP)

(21) Appl. No.: 18/964,761

(22) Filed: Dec. 2, 2024

(30) Foreign Application Priority Data
Dec. 23, 2023 (JP) 2023-209967

(51) Int. Cl. G01N 23/20016; G01N 23/20025; G01N 23/223

(52) U.S. Cl. CPC G01N 23/20016; G01N 23/20025; G01N 23/223; G01N 2223/304

(57) ABSTRACT

A recording apparatus for recording apparatus information for estimating an error cause of a monitored apparatus having a function of outputting the apparatus information and an error signal indicating that an error has occurred when an error has occurred, comprises an apparatus information acquiring section for acquiring a plurality of pieces of the apparatus information from the monitored apparatus, an error signal acquiring section for acquiring the error signal from the monitored apparatus, a holding information indicating section for indicating the apparatus information to be held based on the error signal, and an apparatus information recording section for recording the apparatus information in a predetermined time including ranges before and after a moment at which the error signal has been output based on an indication by the holding information indicating section.

### CROSS-REFERENCE TO RELATED APPLICATION

This application claims priority from Japanese Patent Application No. 2023-209967 filed on Dec. 23, 2023, the entire contents of Japanese Patent Application No. 2023-209967 are incorporated herein by reference.

### BACKGROUND

### Field

The present disclosure relates to a recording apparatus, a system, a method, and a program for recording apparatus information for estimating an error cause of a monitored apparatus.

### Description of the Related Art

When an abnormal situation occurs in various apparatuses such as an X-ray analysis apparatus, an error is displayed in many apparatuses. For example, there is a method in which an error number is notified when an error occurs, and the cause of the error is recognized based on the error number. However, in some cases, it is difficult to identify the cause of the error only by the notification of the error number, and in such cases, the cause of the error is investigated based on the logs accumulated in the apparatus itself or the control section (PC, etc.) of the apparatus.

Patent Document 1 discloses a remote fault diagnosis supporting system in which an operation history, an error history, and the like of an operation input means of a three-dimensional measuring machine are recorded in an operation history file, a measurement screen history is recorded in a measurement screen history file, and the generated history file is transmitted to a service center side via a communication line when a fault occurs. It is described that, as a result, the service person can accurately estimate the cause of the of the fault occurrence by referring to the contents of the history file even if he/she does not go to the site.

Patent Document 2 discloses an analyzer for analyzing a sample, comprising a) an initialization means for performing a self-diagnosis for checking whether or not the initialization of each part of the apparatus and the operation of each part are normal immediately after the power-on or in response to a predetermined instruction, b) an operation history storage means for storing the result in a nonvolatile storage means as an operation history so that the time series order can be identified each time the initialization and self-diagnosis are performed by the initialization means, c) an error history storage means for storing information capable of specifying the type of the device error in the nonvolatile storage means as an error history so that a device error can be associated with the immediately preceding operation history when an analysis is executed and the device error is occurred, d) an output means for reading and outputting the error history stored in the nonvolatile storage means or the operating history corresponding to the error history for display or printing according to a predetermined instruction.

Patent Document 3 discloses an automatic analyzer comprising a plurality of structural elements, output means (sensors), image-recording means, a first storage means, a second storage means, and a control means, wherein the output means (sensors) outputs a signal indicating the error when an error occurs in the structural element, the image-recording means is provided corresponding to the structural element, and records the structural element into a moving image, and the control means causes the first storage means to store the recorded moving image, and when receiving the signal by the output means, extracts the stored data including the moving image recorded by a predetermined time from the time of reception, and causes the second storage means to store the stored data.

### PATENT DOCUMENT

Patent Document 1: JP H11-69467 A1
Patent Document 2: JP Patent No. 4957587
Patent Document 3: JP 2013-148445 A

### SUMMARY

However, in the art of Patent Document 1, since the operation history information and the error history information continue to be recorded in the history file at all times, it needs time and processing ability to extract only the necessary error history information. Further, although the error type is recorded as the error history information, in the case of an error caused by a plurality of causes, it is difficult to estimate the cause from the error type.

Further, in the art of Patent Document 2, since the information immediately before the apparatus error occurs cannot be acquired, it is difficult to estimate the cause of the error. Further, the art of Patent Document 3 is obtained by an application of a conventional drive recorder technique, and it is difficult to apply the technique to a device in which the error is located.

The present disclosure has been made in view of such circumstances, and an object thereof is to provide a recording apparatus, a system, a method, and a program for recording apparatus information for estimating an error cause of a monitored apparatus having a function of outputting apparatus information and an error signal indicating that an error has occurred when an error has occurred.
(1) In order to achieve the above object, the recording apparatus of the present disclosure has the following means. That is, the recording apparatus of an embodiment of the present disclosure is a recording apparatus for recording apparatus information for estimating an error cause of a monitored apparatus having a function of outputting the apparatus information and an error signal indicating that an error has occurred when an error has occurred, comprising an apparatus information acquiring section for acquiring a plurality of pieces of the apparatus information from the monitored apparatus, an error signal acquiring section for acquiring the error signal from the monitored apparatus, a holding information indicating section for indicating the apparatus information to be held based on the error signal, and an apparatus information recording section for recording the apparatus information in a predetermined time including ranges before and after a moment at which the error signal has been output based on an indication by the holding information indicating section.
(2) Further, the recording apparatus according to an aspect of the present disclosure further comprises an error estimating section for estimating an error cause based on the apparatus information recorded by the apparatus information recording section.
(3) Further, in the recording apparatus according to an aspect of the present disclosure, the error estimating section estimates an error cause using a machine-learning model that outputs a score indicating a possibility of an error cause to an input of the apparatus information recorded by the apparatus information recording section.
(4) Further, in the recording apparatus according to an aspect of the present disclosure, the machine-learning model is generated based on training data in which a plurality of types of apparatus information are input and error causes corresponding to the input is output.
(5) Further, in the recording apparatus according to an aspect of the present disclosure, there is a plurality of types of error signals, and the holding information indicating section indicates at least to hold the apparatus information corresponding to the acquired error signal.
(6) Further, in the recording apparatus according to an aspect of the present disclosure, the monitored apparatus is an X-ray analysis apparatus comprising an X-ray generating section for generating X-rays, a sample stage for placing a sample, and a detector for detecting X-rays.
(7) Further, in the recording apparatus according to an aspect of the present disclosure, the apparatus information includes two or more of a tube voltage, a tube current, a degree of vacuum, a filament current, a number of discharges or a bias voltage.
(8) Further, a system according to an aspect of the present disclosure comprises an analysis apparatus having a function of analyzing a sample and outputting the apparatus information and the error signal, and the recording apparatus according to any one of (1) to (7), wherein the monitored apparatus is the analysis apparatus.
(9) Further, a method according to an aspect of the present disclosure is a method applied to a recording apparatus for recording apparatus information for estimating an error cause of a monitored apparatus having a function of outputting the apparatus information and an error signal indicating that an error has occurred when an error has occurred, comprises the steps of acquiring a plurality of pieces of the apparatus information from the monitored apparatus, acquiring the error signal from the monitored apparatus, indicating the apparatus information to be held based on the error signal, and recording the apparatus information in a predetermined time including ranges before and after a moment at which the error signal has been output based on an indication.
(10) Further, a program according to an aspect of the present disclosure is a program for recording apparatus information for estimating an error cause of a monitored apparatus having a function of outputting the apparatus information and an error signal indicating that an error has occurred when an error has occurred, causes a computer to execute the processing of acquiring a plurality of pieces of the apparatus information from the monitored apparatus, acquiring the error signal from the monitored apparatus, indicating the apparatus information to be held based on the error signal, and recording the apparatus information in a predetermined time including ranges before and after a moment at which the error signal has been output based on an indication.

### BRIEF DESCRIPTION OF THE DRAWINGS

FIG. 1 is a block diagram showing an example of a configuration of a system according to a first embodiment of the present disclosure.

FIG. 2 is a flowchart showing an example of an operation of the recording apparatus according to the first embodiment of the present disclosure.

FIG. 3 is a block diagram showing an example of a configuration of a system according to a second embodiment of the present disclosure.

FIG. 4 is a flowchart showing an example of an operation of the recording apparatus according to the second embodiment of the present disclosure.

FIG. 5 is a block diagram showing an example of a configuration of a system according to a third embodiment of the present disclosure.

FIG. 6 is a conceptual diagram showing an example of a configuration of a system according to a fourth embodiment of the present disclosure.

FIG. 7 is a block diagram showing an example of a configuration of a system according to the fourth embodiment of the present disclosure.

FIG. 8 is a block diagram showing a modification of the configuration of the system according to the fourth embodiment of the present disclosure.

FIG. 9 is a block diagram showing a modified example of the configuration of the system according to the fourth embodiment of the present disclosure.

FIG. 10 is a schematic graph showing an example of two pieces of apparatus information having a predetermined time including ranges before and after the moment at which an error signal has been output.

FIG. 11A and FIG. 11B are schematic graphs showing examples of two pieces of apparatus information having predetermined times including ranges before and after the time at which the error signal has been outputted, respectively.

### DETAILED DESCRIPTION

Next, embodiments of the present disclosure are described with reference to the drawings. To facilitate understanding of the description, the same reference numerals are assigned to the same components in the respective drawings, and duplicate descriptions are omitted.

### First Embodiment

### [Whole System]

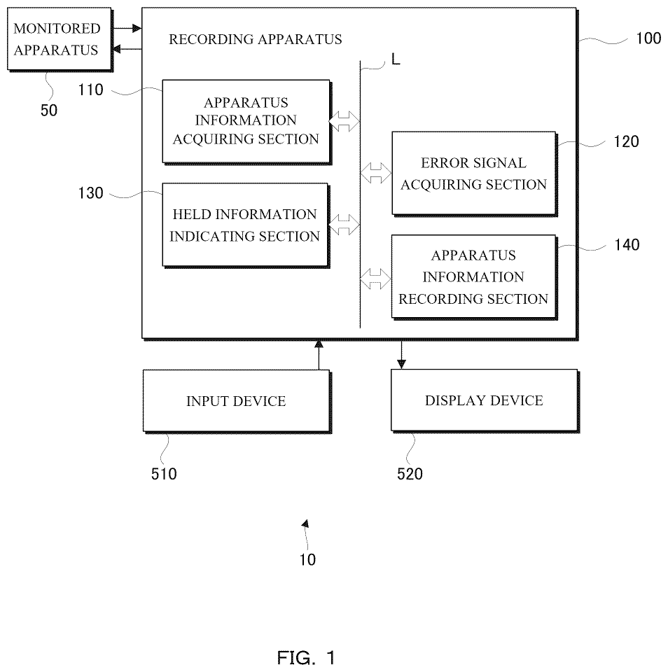

In the first embodiment, a recording apparatus for recording apparatus information for estimating an error cause is described below. FIG. 1 is a block diagram showing an example of a configuration of a system 10 according to the first embodiment. The system 10 comprises a recording apparatus 100 and a monitored apparatus 50.

### [Monitored Apparatus]

The monitored apparatus 50 to which the present disclosure can be applied may be any apparatus as long as it has a function of outputting a plurality of apparatus information and an error signal indicating that an error has occurred when an error has occurred. Details of the apparatus information and the error signal are described below. The present disclosure may be applicable to a monitored apparatus 50 in which the same error may occur due to a plurality of factors, and an error cause can be estimated by confirming a plurality of apparatus information before and after the occurrence of an error.

### [Recording Apparatus]

The recording apparatus 100 is configured by a computer formed by connecting a CPU (Central Processing Unit), ROM (Read Only Memory), RAM (Random Access Memory) and memory to a bus. The recording apparatus 100 may be a PC terminal or a server on a cloud. Not only the whole apparatus but also part of the apparatus or some functions of the apparatus may be provided on the cloud. For example, the recording apparatus 100 may be directly connected to the monitored apparatus 50. The recording apparatus 100 may be provided as a function inside the monitored apparatus 50, for example.

The recording apparatus 100 records apparatus information for estimating an error cause of a monitored apparatus having a function of outputting apparatus information and an error signal. The recording apparatus 100 comprises an apparatus information acquiring section 110, an error signal acquiring section 120, a holding information indicating section 130, and an apparatus information recording section 140. Each section can transmit and receive information via the control bus L.

An input device 510 and a display device 520 are connected to CPU of the recording apparatus 100 via an appropriate interface. The input device 510 is, for example, a keyboard or a mouse, and performs input to the recording apparatus 100. The display device 520 is, for example, a display, and displays apparatus information, the contents of an error signal and the like. In addition, in a case where the recording apparatus 100 comprises an error estimating section 150 described later, the display device 520 may display the estimated error cause.

The apparatus information acquiring section 110 acquires a plurality of pieces of apparatus information from the monitored apparatus 50. The apparatus information is information of the monitored apparatus 50 required for estimating the error cause of the monitored apparatus 50. The apparatus information is information for recognizing a running state, an operation state, and the like of various functions of the monitored apparatus 50, and is output continuously or intermittently at specific timings. The apparatus information is output for a predetermined time even after the error signal is output. The apparatus information may be numerical information or language information. The apparatus information may be information indicating that the value is 0.

The apparatus information acquiring section 110 may continuously acquire the apparatus information all the time. In this case, the acquired apparatus information is temporarily stored in the apparatus information recording section 140 or a storage section different from the apparatus information recording section. The apparatus information acquiring section 110 may acquire the apparatus information simultaneously with the acquisition of the error signal or after the acquisition of the error signal. In this case, the apparatus information is temporarily stored in a storage section in the monitored apparatus 50 or an apparatus having a storage function provided separately therefrom. In any configuration, the apparatus information may be deleted in order from the old apparatus information so that the capacity of the apparatus information to be stored does not become too large, and only the apparatus information for a certain period of time may be stored.

The error signal acquiring section 120 acquires an error signal from the monitored apparatus 50. The error signal is a signal output when an error occurs in the monitored apparatus 50. The error signal may include information of an error occurrence time or an error signal output time. The error signal may be a signal directly output from the monitored apparatus 50 itself. The error signal may be a signal indicating that, if the apparatus information or other information is numerical information, the value is below or above a predetermined threshold. The error signal may be a signal indicating that apparatus information or other information cannot be acquired. A plurality of error signals may be output simultaneously or continuously.

The holding information indicating section 130 indicates apparatus information to be held based on the error signal. The holding information indicating section 130 indicates the apparatus information recording section 140 to hold apparatus information for a predetermined time including ranges before and after the moment at which the error signal has been output.

The predetermined time including ranges before and after the moment at which the error signal has been output is a time acquired by combining a first predetermined time before the time at which the error signal has been output and a second predetermined time after the time at which the error signal has been output. The predetermined time including ranges before and after the moment at which the error signal has been output may be set in advance as a time necessary for estimating the error cause of the monitored apparatus 50. The predetermined time including ranges before and after the moment at which the error signal has been output varies depending on the type and function of the monitored apparatus 50. For example, the first predetermined time period may be 10 seconds or more and 60 seconds or less. Further, for example, the second predetermined time may be 5 seconds or more and 30 seconds or less.

When there is a plurality of types of error signals, the holding information indicating section 130 may indicate at least to hold the apparatus information corresponding to the acquired error signal. Thus, it is possible to reduce the time for confirming the apparatus information in order to estimate the error cause. In addition, the capacity of the apparatus information recording section 140 for recording apparatus information can be reduced. When there is a plurality of types of error signals, the holding information indicating section 130 may determine and indicate the first predetermined time or the second predetermined time based on the type of error signal.

The apparatus information recording section 140 records apparatus information of a predetermined time including ranges before and after the moment at which the error signal is output based on an indication from the holding information indicating section 130. The apparatus information recording section 140 may include a non-volatile memory. The apparatus information of a predetermined time including ranges before and after the moment at which the error signal has been output may be recorded in the non-volatile memory. Thus, even when the power of the recording apparatus 100 or the monitored apparatus 50 is turned off, the apparatus information can be checked later, and the error cause can be estimated. The apparatus information recording section 140 may record the error signal acquired by the error signal acquiring section 120 in addition to the apparatus information.

### [Recording Method of Apparatus Information]

(Description of Flow until Recording Apparatus Information)

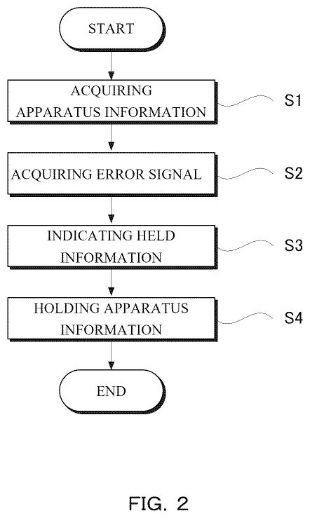

FIG. 2 is a flowchart showing an example of an operation of the recording apparatus 100 according to the first embodiment. FIG. 2 shows an example of an operation until apparatus information is recorded. First, the recording apparatus 100 acquires apparatus information (step S1). Next, an error signal is acquired (step S2). Next, the apparatus information to be held is indicated based on the error signal (step S3). Then, apparatus information of a predetermined time including ranges before and after the moment at which the error signal has been output based on an indication from the holding information indicating section is recorded and held (step S4), and the process ends. The apparatus information may be displayed as necessary. In this way, it is possible to record apparatus information for a predetermined time including ranges before and after the moment at which the error signal has been output.

### Second Embodiment

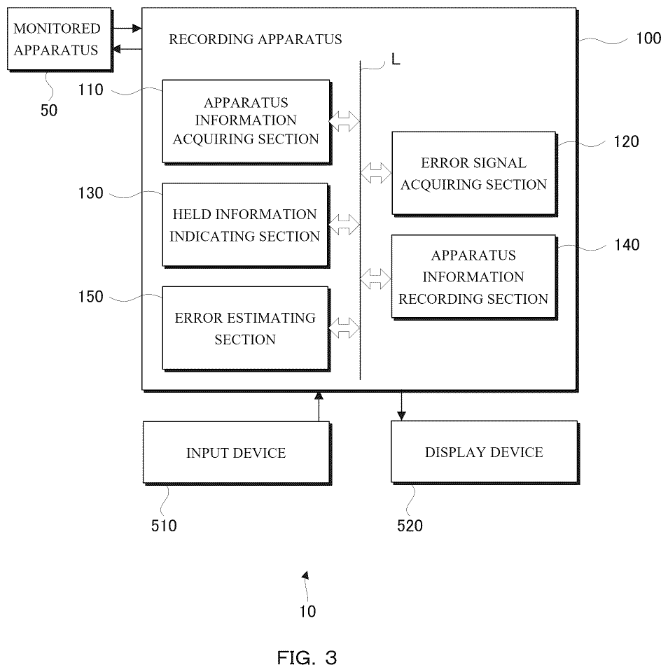

In the second embodiment, a recording apparatus in which apparatus information for estimating an error cause is recorded and an error cause is estimated based on the recorded apparatus information is described. FIG. 3 is a block diagram showing an example of a configuration of the system 10 according to the second embodiment. In the second embodiment, as shown in FIG. 3, the recording apparatus 100 may comprise an error estimating section 150 in addition to the configuration in the first embodiment. The error estimating section 150 estimates the error cause based on the apparatus information recorded by the apparatus information recording section 140.

The error estimating section 150 may estimate an error cause based on a combination of an error signal and apparatus information indicating a behavior different from a normal one among the plurality of pieces of apparatus information. Thus, when the same error may be caused by a plurality of factors, it is possible to estimate a complicated error cause that is not known only by the error signal. The error cause estimated for the combination of the apparatus information and the error signal indicating the behavior different from the normal one among the plurality of pieces of apparatus information may be stored in advance as a table.

The error estimating section 150 may estimate an error cause using a machine-learning model that outputs a score indicating a possibility of an error cause with respect to the input of the apparatus information recorded by the apparatus information recording section 140. Thus, the error cause can be more appropriately estimated. The score indicating the possibility of the error cause is a numerical value indicating the probability for each of the plurality of estimated error causes. Based on the score indicating the possibility of the error cause output by the machine-learning model, one or a plurality of candidates may be presented for the estimated error cause.

The machine-learning model is generated on the basis of training data having a plurality of types of apparatus information as inputs and an error cause corresponding to the inputs as outputs. Machine-learning for the error estimating section 150 is performed in advance. The input of the training data may be all or a part of the apparatus information that can be acquired by the apparatus information acquiring section 110. The input of the training data may include error signals in addition to a plurality of types of apparatus information. The input of the training data may be adapted to the configuration of the data recorded by the apparatus information recording section 140. The plurality of types of apparatus information or error signals as the training data may be virtual data provided by calculation or may be actual measurement data. For the error cause corresponding to the input, a preset error cause may be used, or a true error cause after it is specified may be used. As the learning data including the combination of the apparatus information and the error cause, not only data of one monitored apparatus 50 but also data of a plurality of monitored apparatuses 50 having the same configuration may be used.

When the error estimating section 150 estimates the error cause, the estimated error cause may be recorded together with the apparatus information in the apparatus information recording section 140. The display device 520 may display the estimated error cause. The error estimating section 150 may estimate the cause of the error after a period of time has elapsed from the recording of the apparatus information, such as after the monitored apparatus 50 or the recording apparatus 100 is restarted.

(Description of Flow until Estimating Error Cause)

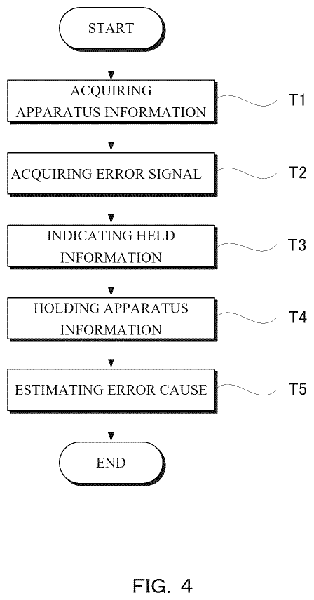

FIG. 4 is a flowchart showing an example of an operation of the recording apparatus 100 according to the second embodiment. FIG. 4 shows an example of an operation until an error cause is estimated. In the description of the present flowchart, the characteristic operation is described in detail, and the description of the operation already described is omitted. The process from acquiring the apparatus information (step T1) to recording and holding the apparatus information (step T4) is the same as the process from step S1 to step S4 described above. Next, the recording apparatus 100 estimates the error cause (step T5), and the process ends. If necessary, the estimated error cause may be stored, and the apparatus information and the error cause may be displayed. In this way, the error cause can be estimated based on the recorded apparatus information.

As described above, the apparatus information may be acquired at all times or may be acquired simultaneously with the acquisition of the error signal or after the acquisition of the error signal. Therefore, in the flowchart of FIG. 2 or FIG. 4, the acquisition of the apparatus information and the acquisition of the error signal may be performed in different order or at the same time.

### Third Embodiment

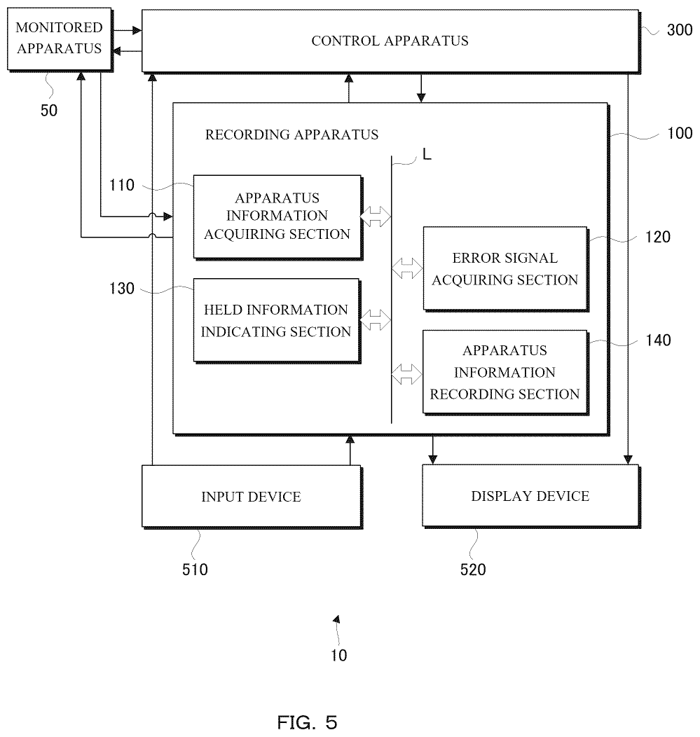

In the first embodiment and the second embodiment, an example in which the recording apparatus 100 is directly connected to the monitored apparatus 50 is described. In the third embodiment, a system in which the control apparatus 300 of the monitored apparatus 50 is provided separately from the monitored apparatus 50 is described. FIG. 5 is a block diagram showing an example of a configuration of the system 10 according to the third embodiment. In FIG. 5, the control apparatus 300 and the recording apparatus 100 are described as different apparatuses, but the same apparatus may be used. The recording apparatus 100 shown in FIG. 5 is configured not to comprise the error estimating section 150 but may also comprise the error estimating section 150 in the present embodiment.

The control apparatus 300 is an apparatus comprising CPU and a memory and may be a PC terminal or a server on a cloud. Not only the whole apparatus but also part of the apparatus or some functions of the apparatus may be provided on the cloud. The input device 510 is, for example, a keyboard or a mouse, and performs input to the control apparatus 300. The display device 520 is, for example, a display, and displays measurement data and the like.

When the control apparatus 300 is provided, the apparatus information acquired by the apparatus information acquiring section 110 may be information acquired via the control apparatus 300. In this case, the apparatus information may be information based on feedback acquired by the control apparatus 300 monitoring the monitored apparatus 50. That is, the apparatus information may be information output by the control apparatus 300.

The apparatus information acquiring section 110 may continuously acquire the apparatus information all the time. The apparatus information acquiring section 110 may acquire the apparatus information simultaneously with the acquisition of the error signal or after the acquisition of the error signal. In this case, the apparatus information is temporarily stored in a storage section in the monitored apparatus 50, the storage section in the control apparatus 300, or an apparatus having a storage function provided separately therefrom.

When the control apparatus 300 is provided, the error signal acquired by the error signal acquiring section 120 may be a signal output from the control apparatus 300. The error signal may be a signal determined on the basis of apparatus information or other information acquired by monitoring the monitored apparatus 50 itself or by the control apparatus 300 monitoring the monitored apparatus 50.

Even in the system 10 comprising the control apparatus 300, the operation of the recording apparatus 100 can be performed in the same manner as the above-described flow.

### Fourth Embodiment

In the fourth embodiment, the recording system 10, the recording apparatus 100 and the control apparatus 300 in the case where the monitored apparatus 50 is the X-ray analysis apparatus 200 are described including examples of specific apparatus information and error signals.

### [Whole System]

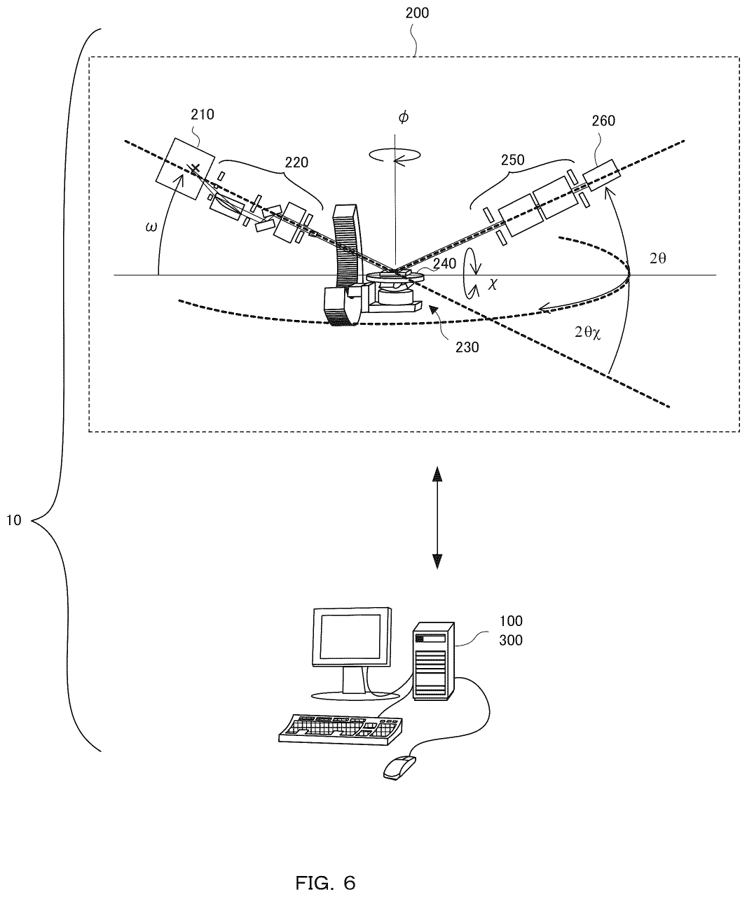

The present disclosure can be made for example, as a system 10 including a recording apparatus 100 and an X-ray analysis apparatus 200. FIG. 6 is a conceptual diagram showing an example of a configuration of the system 10 including a recording apparatus 100, the X-ray analysis apparatus 200, and the control apparatus 300. The system 10 comprises the recording apparatus 100, the X-ray analysis apparatus 200, and the control apparatus 300.

By using such a system 10, when an error occurs in the X-ray analysis apparatus 200, apparatus information for estimating the error cause can be recorded. In addition, the error cause can be estimated.

### [X-Ray Analysis Apparatus]

The X-ray analysis apparatus 200 constitutes an optical system that makes X-rays incident on a sample and detects scattered X-rays and fluorescence X-rays generated from the sample. The X-ray analysis apparatus 200 comprises an X-ray generating section 210 that generates X-rays from an X-ray focal point, that is, X-ray source, an incident side optical unit 220, a goniometer 230, a sample stage 240 on which a sample is placed and a detector 260 that detects X-rays. The X-ray analysis apparatus 200 may comprise an exiting side optical unit 250. The X-ray generating section 210, the incident side optical unit 220, the goniometer 230, the sample stage 240, the exiting side optical unit 250 and the detector 260 that constitute the X-ray analysis apparatus 200 may be those generally available, and thus descriptions are omitted. Incidentally, the configuration shown in FIG. 6 is one example, and thus a variety of other configurations may be adopted.

When the monitored apparatus 50 is the X-ray analysis apparatus 200, the apparatus information may include two or more of a tube voltage, a tube current, a degree of vacuum, a filament current, a number of discharges or a bias voltage. The degree of vacuum is a degree of vacuum in the region where the X-ray generating section 210 is disposed. This makes it easy to estimate the error cause in the case where the error occurs in the X-ray generating section 210. Since the error of the X-ray generating section 210 of the X-ray analysis apparatus 200 often occurs due to a complex factor, the present disclosure may be applied.

A rotating anode X-ray tube may be used as the X-ray generating section 210 of the X-ray analysis apparatus 200. In this case, the X-ray generating section 210 comprises an anode-grounded rotation anticathode part and an electron gun. Further, the electron gun includes an electron emitting part, and a Wehnelt electrode for the electron focusing. Here, the Wehnelt electrode has a structure in which a voltage (bias voltage) lower than a negative voltage applied to the electron emission part is applied.

### [Control Apparatus]

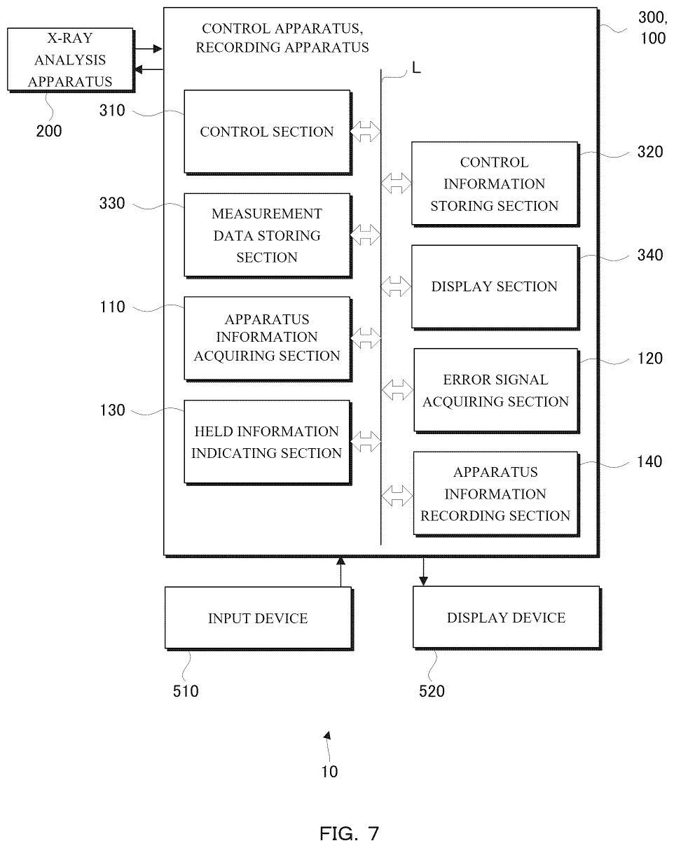

FIG. 7 is a block diagram showing an example of a configuration of the system 10 including the recording apparatus 100, the X-ray analysis apparatus 200 and the control apparatus 300. In FIG. 7, the recording apparatus 100 and the control apparatus 300 are described as an integrated apparatus. The control apparatus 300 is connected to the X-ray analysis apparatus 200 and controls the X-ray analysis apparatus 200 and processes and stores the acquired data. The recording apparatus 100 is a recording apparatus 100 described above.

The control apparatus 300 and the recording apparatus 100 are apparatuses including CPU and memories and may be PC terminals or servers on the cloud. Not only the whole apparatus but also part of the apparatus or some functions of the apparatus may be provided on the cloud. The input device 510 is, for example, a keyboard or a mouse and performs input to the control apparatus 300 or the recording apparatus 100. The display device 520 is, for example, a display and displays measurement data, apparatus information, details of an error signal, an estimated error cause and the like.

The control apparatus 300 includes a control section 310, a control information storing section 320, a measurement data storing section 330 and a display section 340.

The control section 310 controls the operation of the X-ray analysis apparatus 200. The control information storing section 320 stores information necessary for control or sample analysis acquired from the X-ray analysis apparatus 200. The information necessary for control or sample analysis includes information about the X-ray analysis apparatus 200, such as apparatus name, source type, wavelength, background, etc. In addition, necessary information among information such as a shape, arrangement, type of constituent elements, composition and absorption coefficient of a sample may be included. The control information storing section 320 may temporarily store apparatus information.

The measurement data storing section 330 stores measurement data acquired from the X-ray analysis apparatus 200. The measurement data may include necessary information such as source type, wavelength, background, sample shape, arrangement, constituent element type, composition, and absorption coefficient. The display section 340 displays the measurement data on the display device 520. Thus, the measurement data can be confirmed by a user. Further, instruction and designation to the control apparatus 300 and so forth can be made based on the measurement data by the user.

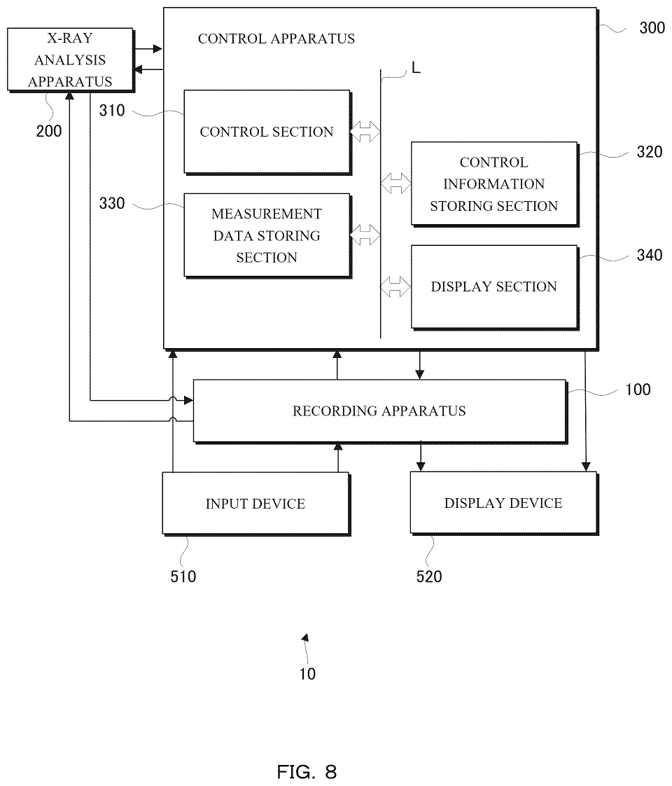

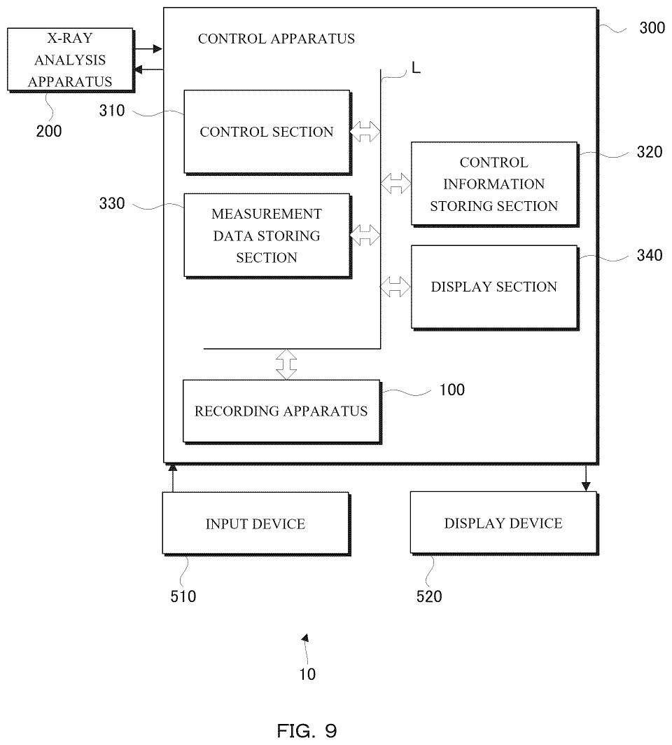

In FIG. 6, the control apparatus 300 and the recording apparatus 100 are described as the same PC. In FIG. 7, the control apparatus 300 and the recording apparatus 100 are described as an integrated apparatus. However, as described above, in the method of the present disclosure, when the apparatus information and the error signal are output from the X-ray analysis apparatus 200, the apparatus information and the error signal can be acquired without being relayed by the control apparatus 300, and the apparatus information can be recorded, or the error cause can be estimated. Therefore, as shown in FIG. 8, the recording apparatus 100 may be configured as a different apparatus from the control apparatus 300. As shown in FIG. 9, the recording apparatus 100 may be configured as a part of functions included in the control apparatus 300. FIG. 8 and FIG. 9 are block diagrams showing modified examples of the configuration of the system 10 including the recording apparatus 100, the X-ray analysis apparatus 200 and the control apparatus 300.

### [Measurement Method]

A sample is set in the X-ray analysis apparatus 200, and the goniometer is driven under a predetermined condition under the control of the control apparatus 300. The X-ray analysis apparatus 200 repeats the movement of the rotation axis and the projection of the X-ray under predetermined conditions. The sample is irradiated with X-rays, and scattered X-rays, transmitted X-rays, fluorescent X-rays and the like generated from the sample are detected. Thus, measurement data such as X-ray reflectance data, X-ray small-angle scattering data or fluorescence X-ray data is acquired. The X-ray analysis apparatus 200 transmits the acquired measurement data to the control apparatus 300. The X-ray analysis apparatus 200 may transmit the apparatus information during measurement to the control apparatus 300. When an error occurs, the X-ray analysis apparatus 200 transmits an error signal to the control apparatus 300. When the recording apparatus 100 is configured as an apparatus different from the control apparatus 300, the apparatus information or the error signal may be directly transmitted to the recording apparatus 100.

### [Estimation Example of Error Cause]

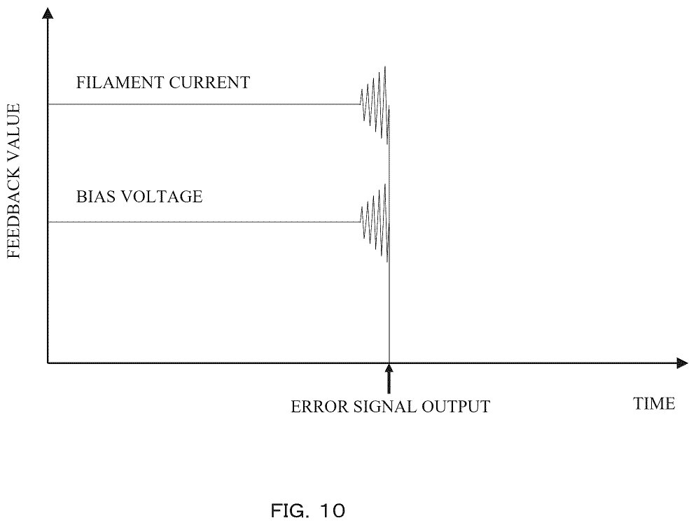

(1) Consider a case where an error signal is output indicating that an abnormality in the filament current is detected. FIG. 10 is a schematic graph showing an example of two pieces of apparatus information having a predetermined time including ranges before and after the moment at which the error signal has been output. The two pieces of apparatus information in FIG. 10 are the filament current and the feedback value (analog voltage signal output) of the bias voltage. In FIG. 10, an error signal is output indicating that an abnormality in the filament current is detected.

When an error signal is output indicating that an abnormality in the filament current is detected, the cause of the abnormality in the filament current is not known in the prior art. However, as in the example of the present disclosure, when the filament current and the bias voltage are set as the apparatus information and the apparatus information for a predetermined time including ranges before and after the moment at which the error signal has been output is recorded, it can be estimated that the cause of the abnormality of the filament current is the disturbance of the bias voltage.

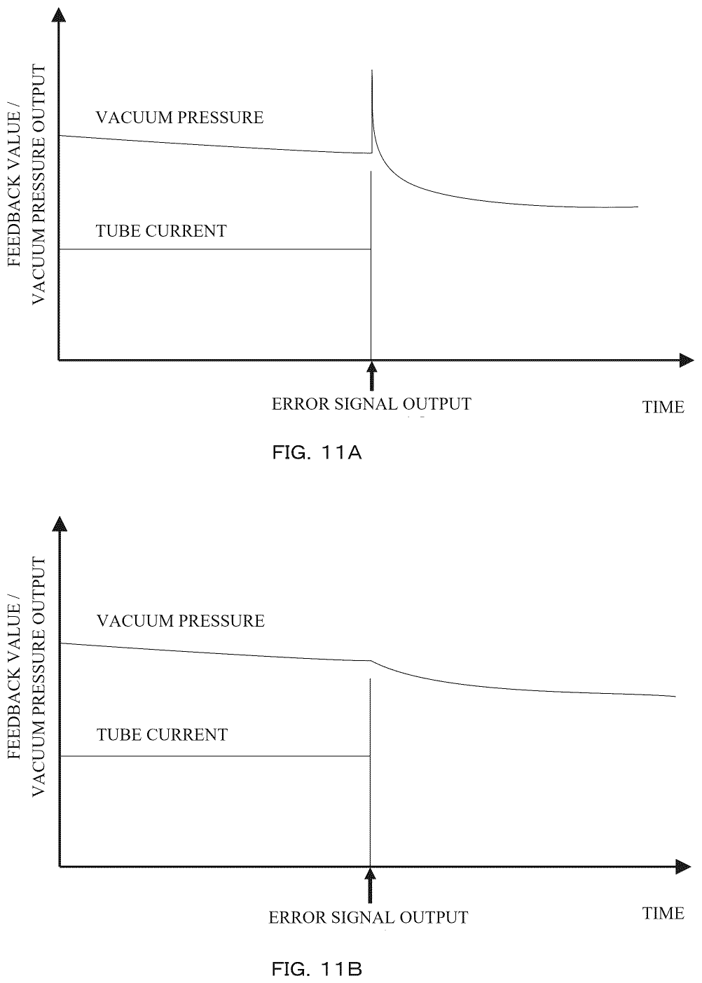

(2) Consider a case where an error signal is output indicating that an increase in a tube current component other than thermoelectrons generated from a filament or a fall in a tube voltage associated therewith, that is, an abnormality in a tube current or a tube voltage (hereinafter referred to as “discharge”) is detected. FIGS. 11A and 11B are schematic graphs showing examples of two pieces of apparatus information having predetermined times including ranges before and after the time at which the error signal has been outputted, respectively. The two pieces of apparatus information in FIGS. 11A and 11B are the measured vacuum pressure output value inside the tube and the tube current feedback value (analog voltage signal output). In each of FIGS. 11A and 11B, an error signal is output indicating that the discharge is detected.

In FIG. 11A, the vacuum pressure is temporarily increased (the degree of vacuum is deteriorated) at the time of outputting the error signal. In contrast, in FIG. 11B, the vacuum pressure is not increased at the time of outputting the error signal. By evaluating the discharge and vacuum pressure complexly, it can be estimated in FIG. 11A that the discharge is occurring in the bulb. In addition, in FIG. 11B, it can be estimated that discharge occurs outside the bulb of the power supply unit or the like.

In a case where an error signal is output indicating that the discharge is detected, the cause of the discharge is not known in the prior art. However, in the case where the vacuum pressure and the tube current are set as the apparatus information and the apparatus information for a predetermined time including ranges before and after the moment at which the error signal has been output is recorded as in the example of the present disclosure, the error cause can be estimated by the above-described complex evaluation. The reason why the vacuum pressure decreases after the error signal is output in both the shown FIG. 11A and FIG. 11B is that the X-ray is not generated due to the error.

As described above, the recording apparatus, the system, the method, and the program of the present disclosure can record apparatus information for a predetermined time including ranges before and after the moment at which the error signal has been output. Further, the error cause can be estimated based on the recorded apparatus information.

Needless to say, the present disclosure is not limited to the above-described embodiments. The scope of the present disclosure covers various modifications and equivalents included in the technical idea of the present disclosure. In addition, the names, structures, shapes, numbers, positions, sizes and the like of the constituent elements shown in the drawings are for convenience of explanation and may be changed as appropriate.

### DESCRIPTION OF SYMBOLS

10 system
50 monitored apparatus
100 recording apparatus
110 apparatus information acquiring section
120 error signal acquiring section
130 holding information indicating section
140 apparatus information recording section
150 error estimating section
200 X-ray analysis apparatus
210 X-ray generating section
220 incident side optical unit
230 goniometer
240 sample stage
250 exiting side optical unit
260 detector
300 control apparatus
310 control section
320 control information storing section
330 measurement data storing section
340 display section
510 input device
520 display device
L control bus

What is claimed is:

1. A recording apparatus for recording apparatus information for estimating an error cause of a monitored apparatus having a function of outputting the apparatus information and an error signal indicating that an error has occurred when an error has occurred, comprising:
processing circuitry configured to
acquire a plurality of pieces of the apparatus information from the monitored apparatus,
acquire the error signal from the monitored apparatus,
indicate the apparatus information to be held based on the error signal, and
record the apparatus information in a predetermined time including ranges before and after a moment at which the error signal has been output.

2. The recording apparatus according to claim 1, wherein the processing circuitry is further configured to
estimate an error cause based on the recorded apparatus information.

3. The recording apparatus according to claim 2, wherein the processing circuitry is further configured to
estimate an error cause using a machine-learning model that outputs a score indicating a possibility of an error cause to an input of the recorded apparatus information.

4. The recording apparatus according to claim 3, wherein
the machine-learning model is generated based on training data in which a plurality of types of apparatus information are input and error causes corresponding to the input are output.

5. The recording apparatus according to claim 1, wherein
there are a plurality of types of error signals, and the processing circuitry is further configured to
indicate at least to hold the apparatus information corresponding to the acquired error signal.

6. The recording apparatus according to claim 1, wherein
the monitored apparatus is an X-ray analysis apparatus comprising a rotating anode X-ray tube for generating X-rays, a sample stage for placing a sample, and a detector for detecting X-rays.

7. The recording apparatus according to claim 6, wherein
the apparatus information includes two or more of a tube voltage, a tube current, a degree of vacuum, a filament current, a number of discharges or a bias voltage.

8. A system comprising:
an analysis apparatus having a function of analyzing a sample and outputting the apparatus information and the error signal, and
the recording apparatus according to claim 1, wherein
the monitored apparatus is the analysis apparatus.

9. A method applied to a recording apparatus for recording apparatus information for estimating an error cause of a monitored apparatus having a function of outputting the apparatus information and an error signal indicating that an error has occurred when an error has occurred, the method comprising:
acquiring a plurality of pieces of the apparatus information from the monitored apparatus,
acquiring the error signal from the monitored apparatus,
indicating the apparatus information to be held based on the error signal, and
recording the apparatus information in a predetermined time including ranges before and after a moment at which the error signal has been output based on an indication.

10. A non-transitory computer readable recording medium having recorded thereon a program for recording apparatus information for estimating an error cause of a monitored apparatus having a function of outputting the apparatus information and an error signal indicating that an error has occurred when an error has occurred, the program causing a computer to perform a method, comprising:
acquiring a plurality of pieces of the apparatus information from the monitored apparatus,
acquiring the error signal from the monitored apparatus,
indicating the apparatus information to be held based on the error signal, and
recording the apparatus information in a predetermined time including ranges before and after a moment at which the error signal has been output based on an indication.
